(19) United States
(12) Patent Application Publication
(10) Pub. No.: US 2012/0299266 A1
(43) Pub. Date: Nov. 29, 2012

(54) STEP FOR VEHICLE HITCH

(76) Inventor: Preston DeWitt Gordon, Rochester Hills, MI (US)

(21) Appl. No.: 13/463,567

(22) Filed: May 3, 2012

Related U.S. Application Data
(60) Provisional application No. 61/481,868, filed on May 3, 2011.

(51) Int. Cl. B60R 3/00

(52) U.S. Cl. 280/163

(57) ABSTRACT

A step platform for a trailer hitch has a bottom surface that is configured to engage and be supported by a trailer hitch. The step platform includes an upper surface that is substantially planar from one side to the other. The step platform has a ball mount opening located adjacent to the outer edge for facilitating attachment of a ball mount to the trailer hitch. A mount orifice is formed in the step platform for receipt of a portion of the trailer hitch to provide stability to the step.

### CROSS-REFERENCE TO RELATED APPLICATIONS

The present application claims priority to U.S. Provisional Patent Application Ser. No. 61/481,868, entitled “Step for a Vehicle Hitch”, which was filed on May 3, 2011 and is hereby incorporated by reference as though set forth fully herein.

### TECHNICAL FIELD

The present invention generally relates to a step platform for attachment at the rear of a vehicle. More specifically, the present invention relates to a step platform for attachment to a vehicle trailer hitch.

### BACKGROUND OF THE INVENTION

Trailer hitches for vehicles, such as automobiles and trucks, are well known. In general, trailer hitches for vehicles include a hitch frame having a receiver attached to the vehicle that is intended to engage a drawbar that can be locked in place. A ball mount is attached to the rear end of the drawbar and includes an opening for mounting a hitch ball, which can engage a trailer.

When a trailer is attached to a vehicle, a user who desires to walk from one side of the vehicle to the other typically has to pass entirely around the trailered structure. This is because the trailer hitch blocks a user's path requiring them to step over it to get to the other side of the vehicle. As these structures are typically 18 inches or so off the ground, a user who does not want to walk around the entire vehicle, often steps onto the structures or steps over them, which can be dangerous. In the case of a boat launch or recovery situation, this can be particularly unsafe as the components are generally wet and the vehicle and trailer are parked on an inclined ramp surface.

To avoid this situation and minimize the necessity of having a user walk the long path from one side of the vehicle to the other around the trailered structure or the front of the vehicle if they are located near the back, step structures have been utilized on the back of the vehicle, including as part of the trailer hitch. However, prior trailer hitch steps are generally expensive, cumbersome, and suffer from various disadvantages. It would thus be desirable to prove a trailer hitch step for a vehicle that overcomes these and other disadvantageous.

### SUMMARY OF THE PRESENT INVENTION

It is an advantage of the present invention to provide a step platform for a vehicle that makes it easier for a user to reach the rear or top of the vehicle.

It is a related advantage of the present invention to provide a step platform for a vehicle that makes it easier and safer for a user to step over a trailer hitch when a structure is trailered to the vehicle.

It is another advantage of the present invention to provide a step platform that can be utilized in connection with vehicles having a trailer hitch.

It is still another advantage of the present invention to provide a step platform for a trailer hitch that can be easily attached to a vehicle without the need for attachment hardware.

It is yet another advantage of the present invention to provide a step platform for a vehicle that provides improved stability for a trailer hitch step.

In accordance with the above and the other advantages of the present invention, a step platform for a trailer hitch is provided. The step platform includes a bottom surface that is configured to engage and be supported by a drawbar of a trailer hitch. The step platform has an upper surface that is substantially flat along its entire surface. The upper surface includes an opening that is configured to receive a stem of a hitch ball therethrough to assist in securing the step platform to the vehicle. The upper surface includes a slot that is configured to receive a receiver portion of the trailer hitch therein.

Other advantages of the present invention will be readily appreciated, as the same becomes better understood by reference to the following detailed description when considered in connection with the accompanying drawings.

### BRIEF DESCRIPTION OF THE DRAWINGS

FIG. 1 is perspective view of a step platform for a vehicle trailer hitch in accordance with a preferred embodiment of the present invention;

FIG. 2 is top view of the step platform of FIG. 1;

FIG. 3 is a front view of the trailer hitch with attached step platform of FIG. 1;

FIG. 4 is a cross-sectional view illustrating the assembly of a step platform to a trailer hitch in accordance with the present invention;

FIG. 5 is an end view of a trailer hitch with an attached step platform in accordance with another embodiment of the present invention;

FIG. 6 is a top view of the step platform of FIG. 5;

FIG. 7 is a perspective view of a trailer hitch and attached step platform in accordance with still another embodiment of the present invention;

FIG. 8 is a perspective view of a trailer hitch and attached step platform in accordance with yet another embodiment of the present invention;

FIG. 9 is a perspective view of a trailer hitch and attached step platform in accordance with a further embodiment of the present invention; and

FIG. 10 is a perspective view of a trailer hitch and attached step platform in accordance with yet still a further embodiment of the present invention.

### DETAILED DESCRIPTION OF THE ENABLING EMBODIMENTS

The present invention relates to a step platform 10 for attachment to a rear of a vehicle. Specifically, as shown in the attached Figures, the platform 10 is intended for attachment to a trailer hitch 12. The trailer hitch 12 generally includes a receiver structure that is secured to the rear of the vehicle and a drawbar, including a ball mount that is intended to fit within the receiver and project rearward from the vehicle to engage a trailer. The trailer hitch 12 can take on a variety of other configurations with other components.

As shown in the Figures, the platform 10 can include a generally rectangular shape with an inner edge 20, an outer edge 22, and a pair of side edges 24. These edges bound and define an upper surface 26, which is the area upon which a user can step. In accordance with one aspect, the upper surface 26 is substantially flat. Alternatively, the upper surface 26 can be entirely flat or curved. The platform 10 can take on a variety of other suitable shapes and sizes. The platform 10 includes a circular shaped ball mount receiving orifice 14 and a rectangular shaped mount orifice 16. It will be understood that the orifices 14 and 16 can take on various sizes and shapes. Similarly, the platform 10 can be employed with a variety of different styles and configurations of trailer hitches 12, as discussed below. The configuration of the trailer hitch and ball mount are not critical, for example, the step platform can be used with both Class II and Class III hitches. The configuration of the platform 10 allows it to be attached to the vehicle readily without any attachment hardware required. The configuration yields a step that does not interfere with trailer hitch function.

In one aspect, the platform 10 is constructed of steel. However, it will be understood that it can be manufactured from a variety of other suitable metals. It can also be constructed of other suitable materials, such a plastic or fiberglass. Additionally, the trailer hitch 12 could be formed or painted with a bright color to provide improved visibility. Alternatively, a reflective finish could be employed on the upper surface of the hitch.

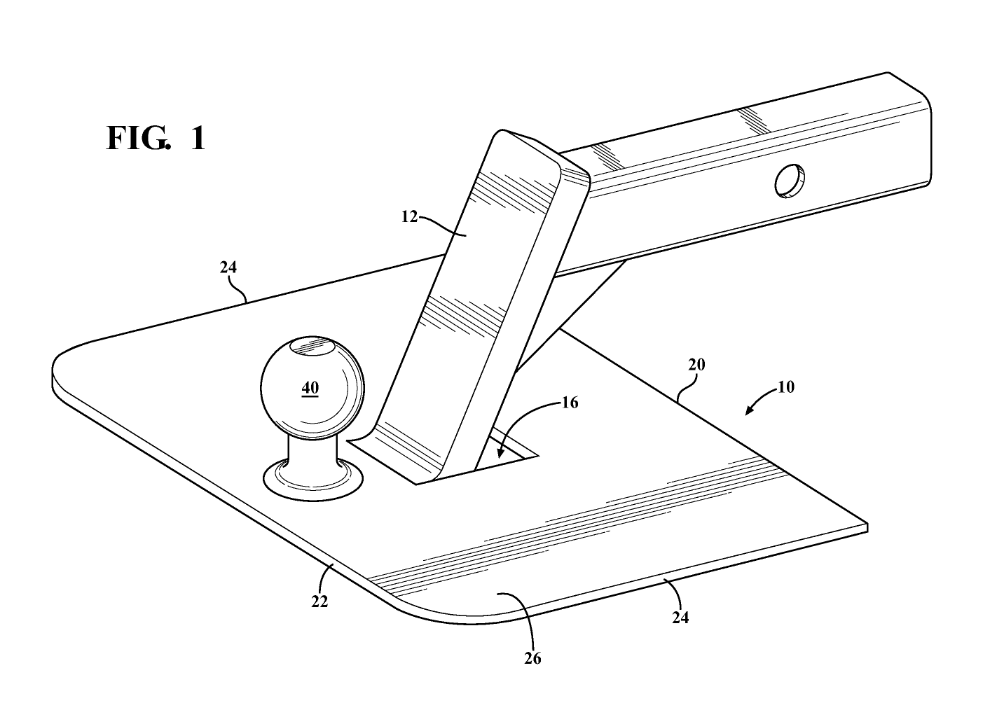

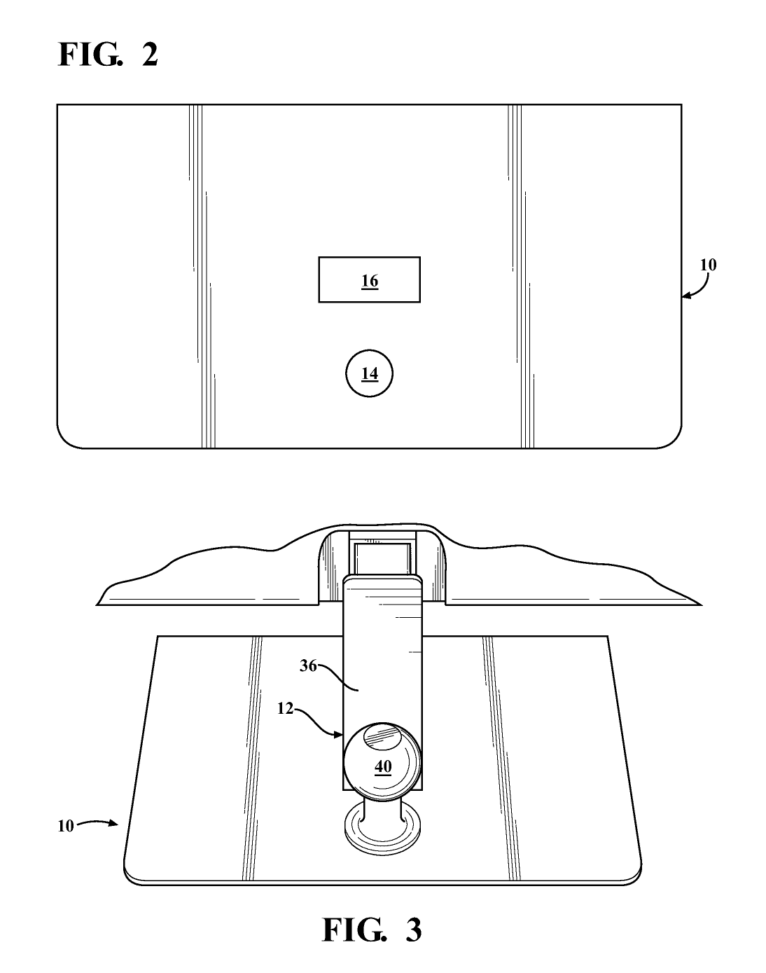

As shown in FIG. 1 through 3, the step platform 10 has a rectangular shaped opening that is intended to receive the second leg 36 of trailer hitch 12. As also shown, the ball mount 40 is located adjacent the rearward or outer edge 22 of the step platform 10. This helps minimize the potential for the step 10 to interfere with the attachment of a trailer.

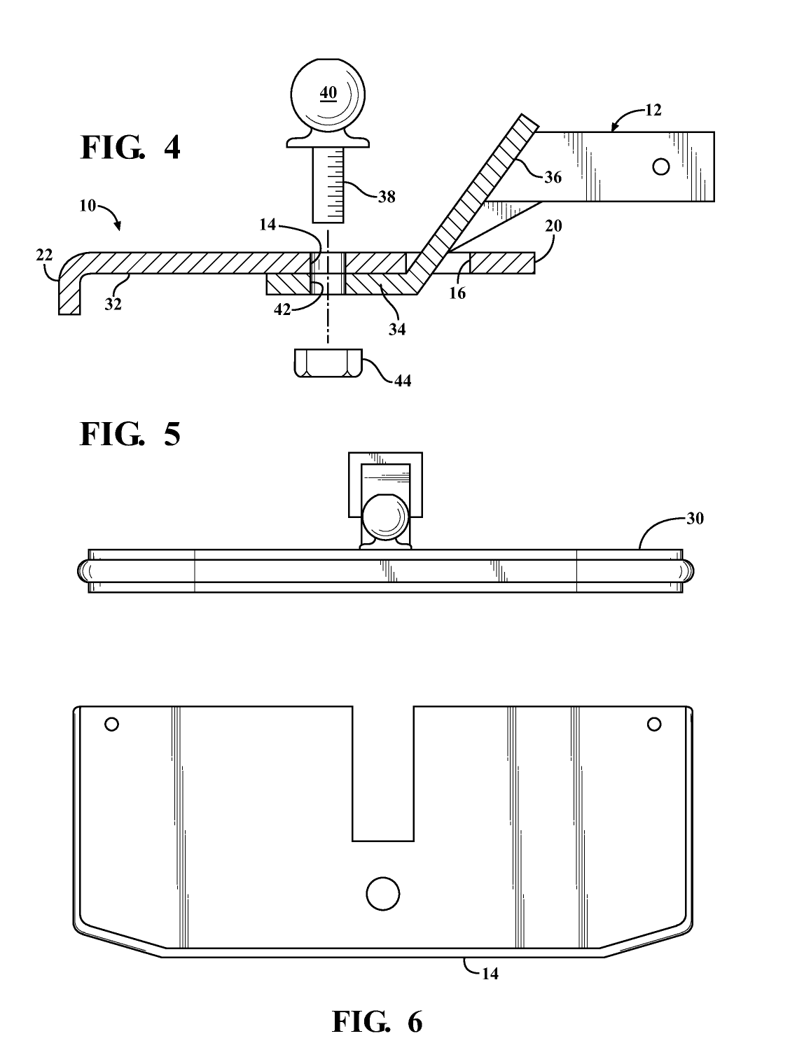

As shown in FIG. 4, the platform 10 also includes a bottom surface 32 that can rest on a first leg 34 of the trailer hitch 12. A second leg 36 of the trailer hitch 12 extends through the mount orifice 16 for restricting relative rotary movement between the platform 10 and the trailer hitch 12. The trailer hitch 12 includes a threaded shaft 38 attached to a hitch ball 40, which is configured to extend through the ball orifice 14 and through a leg orifice 42 on the first leg 34 of the trailer hitch 12. A locking nut 44 can be threaded onto the threaded shaft 38 to secure the hitch ball 40, the platform 10 and the first leg 34 of the trailer hitch 12 together to restrict relative vertical motion between the components.

FIGS. 5 and 6 illustrate another step platform 10 and trailer hitch 12 in accordance with another aspect of the invention. As shown, the mount orifice 16 opening in the platform 10 is configured as a channel 50 that receives the second leg 36 of the hitch ball mount 12, instead of a mount orifice 16. Additionally, the step platform 10 includes a downwardly extending flange 30 that projects downward along the outer edge 22 of the step platform 10. The step platform 10 can also include a downwardly extending flange 30 along the inner edge 20 and/or the pair of side edges 24.

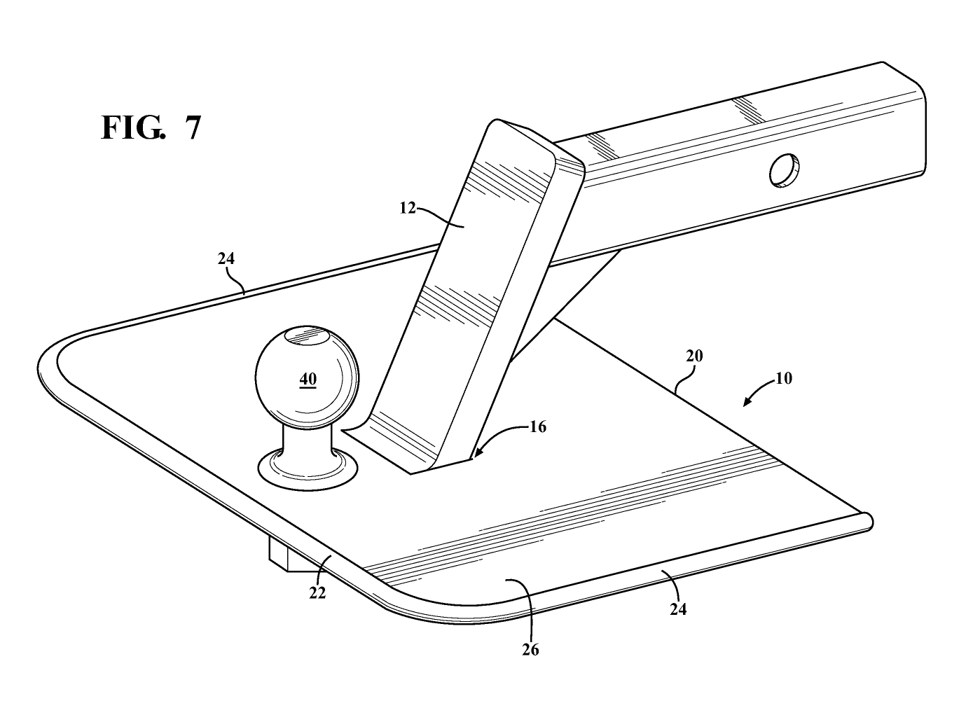

FIG. 7 illustrates another aspect of the invention, where a bumper 52, such as one constructed of rubber, preferably extends around the perimeter of the step platform 10. This yields a structure that reduces any potential injury from bumping into the trailer hitch 12 or step platform 10. The bumper 52 could alternatively only extend around a portion of the perimeter.

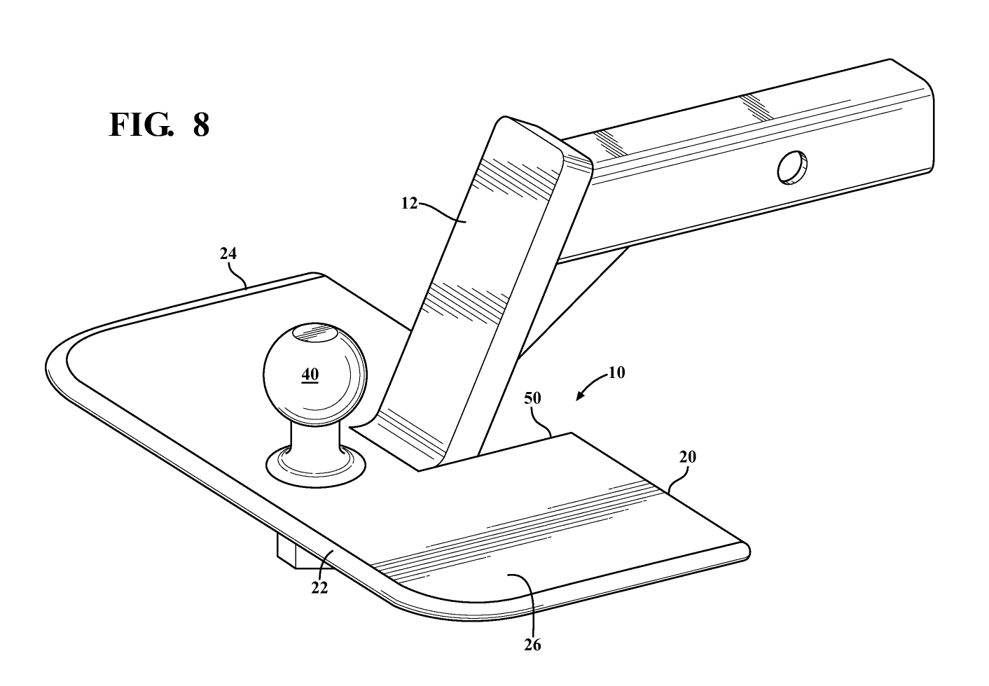

FIG. 8 illustrates another aspect of a step platform 10 for attachment to a trailer hitch 12. In accordance with this aspect, the step platform 10 has a smaller distance between the inner edge 20 and the outer edge 22 as compared to other embodiments.

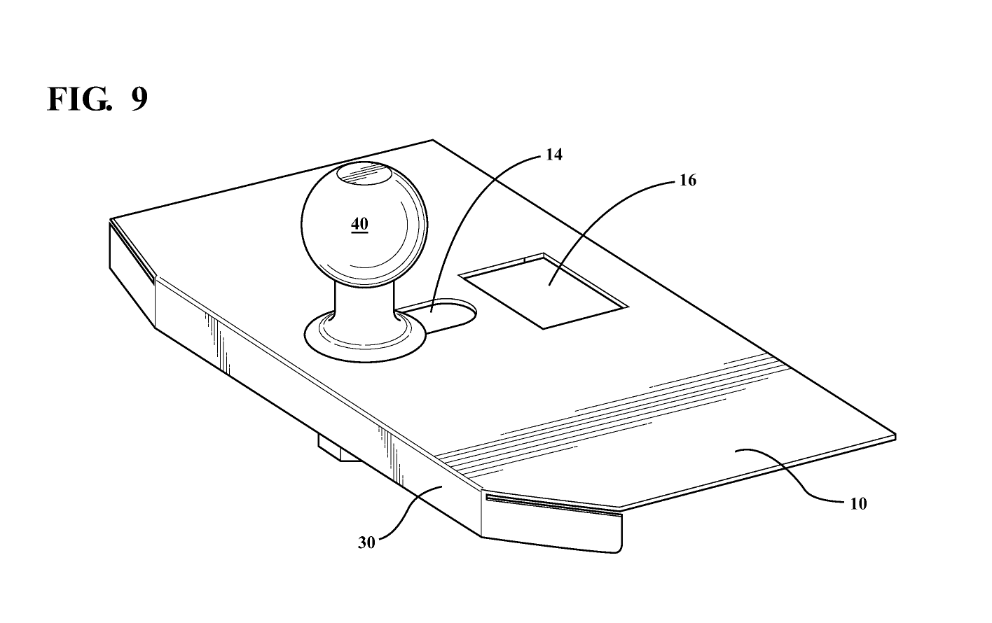

FIG. 9 illustrates still another aspect of a step platform 10. As illustrated, the step platform 10 has a different shape with an angled outer edge 22. As the outer edge 22 of the step platform 10 is angled, the downwardly extending flange 30 in this aspect is angled.

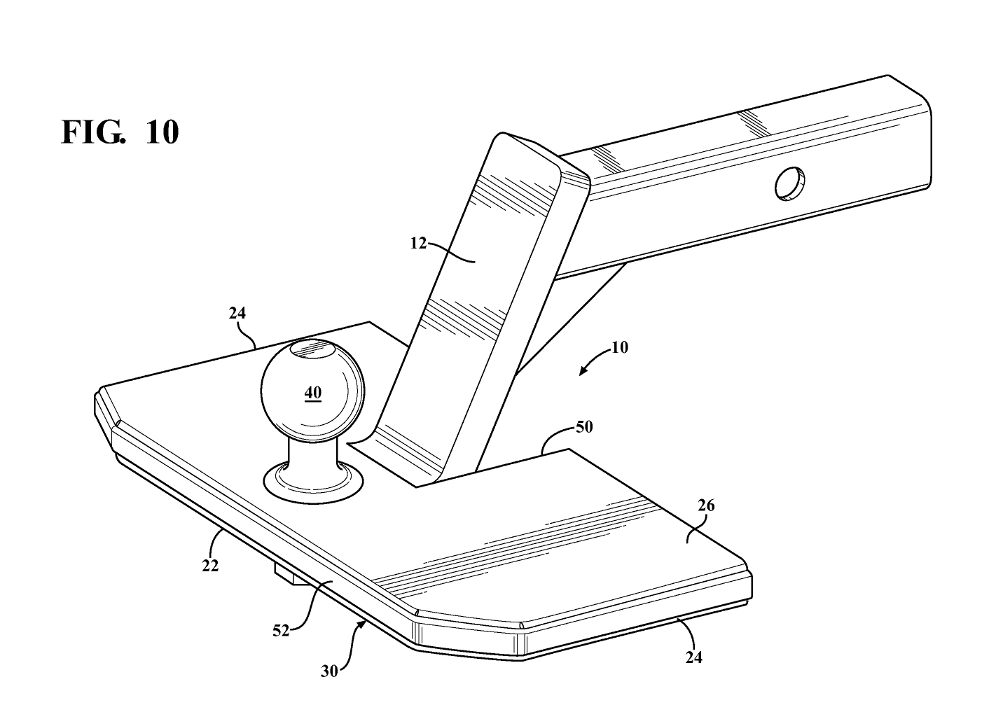

FIG. 10 illustrates still another embodiment of a trailer hitch 12 with a step platform 10. In accordance with this aspect, the step platform 10 is a non-rectangular structure with a slot 50. The step platform 10 includes a downwardly extending flange 30 along the outer edge 22 and the pair of side edge 24. Additionally, a bumper 52 is disposed on the downwardly extending flange 30.

Obviously, many modifications and variations of the present invention are possible in light of the above teachings and may be practiced otherwise than as specifically described. These antecedent recitations should be interpreted to cover any combination in which the inventive novelty exercises its utility.

What is claimed:

1. A step platform for a trailer hitch, comprising:
an upper surface that is substantially planar;
a lower surface that is configured to engage a portion of the trailer hitch;
a ball mount opening that facilitates attachment of a ball mount disposed on said upper surface and said portion of the trailer hitch engaging said lower surface;
a mount opening formed for receipt of another portion of the trailer hitch to provide stability;
said ball mount opening being formed adjacent an outer edge of said upper surface through said substantially planar upper surface such that said ball mount will provide stability directly thereto.

2. The step platform of claim 1, further comprising:
a flange extending downward from at least a portion of an outer perimeter of the step platform.

3. The step platform of claim 2 wherein said flange extends downwardly from said outer surface and a pair of opposing side surfaces.

4. The step platform of claim 1, further comprising:
a bumper disposed around at least a portion of a perimeter of the step platform.
